(19) United States
(12) Patent Application Publication
(10) Pub. No.: US 2012/0175522 A1
(43) Pub. Date: Jul. 12, 2012

(54) THERMAL INFRARED SIGNAGE, METHOD OF MAKING AND METHOD OF USE THEREOF FOR INFRARED WEAPON SIGHT CALIBRATION

(76) Inventor: THOMAS ROBERT BOYER, GAMBRILLS, MD (US)

(21) Appl. No.: 13/004,759

(22) Filed: Jan. 11, 2011

(51) Int. Cl. G01J 5/02

(52) U.S. Cl. 250/340

(57) ABSTRACT

An improved signage visible by infrared cameras and infrared weapon sights is provided. Particular application is made to the calibration of infrared weapon sights. A method of preparing the signage is disclosed. A method of using the signage for weapon calibration to a desired target is also disclosed.

### FIELD OF THE INVENTION

This invention relates to signage for infrared imaging techniques. In particular, the present invention relates to articles of manufacture useful as signage or identifiers of objects using infrared radiation, the method of preparing the articles and the method of using the articles to target and calibrate infrared weapon sights. The invention is particularly useful in the field of firearms.

### BACKGROUND OF THE INVENTION

Infrared cameras permit weapon users, such as military and police personnel, to view heat sources, such as people, in complete darkness. However, infrared imaging technology has heretofore been incapable of differentiating words or symbols. To convey information, infrared imaging techniques typically have required the use of heated objects, such as exothermic chemical heaters. However, such technologies only create a point in the imaging system, thereby limiting the ability to convey complex information.

In particular, infrared weapon sights such as the TWS (Thermal Weapon Sight) from BAE, DRS Technologies, or Raytheon must be calibrated to ensure hitting a designated target. This is very important whenever the sight has been disturbed in any way. Using traditional iron sights, the user fires groups of shots at the center of a target similar to the target shown in FIG. 3. The shots are expected to land a predefined distance away from the target center depending on the weapon and sight characteristics. If the shots do not hit the target where expected, the sights must be calibrated to hit the target in the predefined position. However, the soldier using a thermal weapon sight is unable to see the target to perform this calibration procedure.

Attempts have been made to overcome infrared sighting problems. For example, Migliorini (U.S. Pat. No. 6,337,475) proposes using a small electrically heated silhouette placed on the front of a standard 25 meter zeroing target. This device requires a battery for operation, which poses certain logistical problems and may increase costs. Further, heat leakage from the silhouette can result in lower accuracy.

Boyer (U.S. Pat. No. 7,528,397) discloses an infrared sight calibration device that comprises an industry standard thermal infrared reflective film characterized by simple reflection. As shown in FIG. 1, the angle δ between a ray striking the surface and a line, AA, perpendicular to the surface of the reflective film, is exactly equal to the angle ε between the reflected ray and the same perpendicular line, AA. The film must be oriented at an angle of approximately 15° relative to vertical in order for the required thermal reflective characteristics to be realized.

Others proposed devices, methods, and means for sighting of infrared optical devices include those described in U.S. Pat. No. 6,767,015, which discloses a thermal target; U.S. Pat. No. 6,051,840, which discloses an infrared heat emitting device; U.S. Pat. No. 6,020,040, which discloses a thermal pack having a plurality of individual heat cells; and U.S. Pat. No. 5,918,590, which discloses heat cells.

Consequently, there remains a need for improved signage or markers for detecting infrared radiation, which overcome sighting problems previously associated with infrared imaging techniques.

### SUMMARY OF THE INVENTION

A physical object which is useful as a visible detector or signage of infrared radiation has been developed. In general, the signage device of the invention comprises a laminar member having a first surface and second surface. Preferably, the laminar member comprises a multilayered structure comprising two or more materials generally capable of properly interfacing with each other and any subsequent layers adhered thereto. The second surface of the laminar member is a low emissivity surface characterized as having an emissivity value of about 0.4 or less than 0.4. Generally, the low emissivity surface comprises a surface construction such that when the laminar member is oriented vertical or substantially vertical to the earth at least a portion of the thermal energy of the sky striking the low emissivity surface is reflected away from the surface towards an observer. Preferably, thermal energy striking the low emissivity surface is reflected perpendicular or substantially perpendicular away from the surface towards an observer. Advantageously, the signage of the invention can be printed on the low emissivity surface to alter emissivity and provide a design which will be readily apparent when viewed through an infrared imaging device. Alternatively, at least a portion of the laminar member may be removed or “cutout” to alter emissivity and provides a pattern or design detectable by infrared imaging.

In a preferred embodiment of the invention, the signage of the invention is useful for targeting and calibrating an infrared scope or sight to a weapon. Preferably, the weapon is a firearm. Accordingly, the present invention also comprises a method of making a signage or object for targeting and calibrating an infrared scope to a weapon. The signage of the invention is generally prepared by forming an object that is visible when using an infrared optical device, such as an infrared camera or infrared optical sighting device for a weapon. The method of the invention provides an object that contains words, characters, graphics, and/or images that can be detected with an infrared detector, but may or may not be detectable by the naked eye. In general, the method comprises providing an object with at least one surface having a low emissivity value (i.e. an emissivity value of about 0.4 or less) and when oriented vertical or substantially vertical the earth, having the ability to reflect at least a portion of the thermal energy from the sky striking the low emissivity surface towards an observer; and modifying the surface emissive characteristic of at least a portion of the low emissivity surface by depositing on the surface one or more substances that can be detected with a device sensitive to infrared electromagnetic radiation, or by removing at least one portion of the low emissivity surface to alter emissivity.

In another embodiment of the invention, a method of calibrating an infrared weapon sight using the signage of the invention is provided. In accordance with the present invention, the method of calibrating an infrared weapon sight comprises viewing the object or signage of the invention through an infrared sight, and determining whether the sight is calibrated to the weapon, that is whether the point of impact of shots fired from the weapon corresponds to the point of aim of the sight. Optionally, where the determining step identifies an improper calibration, the method typically further comprises adjusting the sight to more accurately calibrate to the weapon. Often, the method will be practiced under controlled conditions, such as at a shooting range or on a military or police facility.

In one embodiment of the invention, at least a portion of the signage is heated to increase clarity during infrared imaging. Preferably, the heat may be applied using a chemical or an electrical heat source.

### BRIEF DESCRIPTION OF THE DRAWINGS

FIG. 1 is an illustration of simple reflection

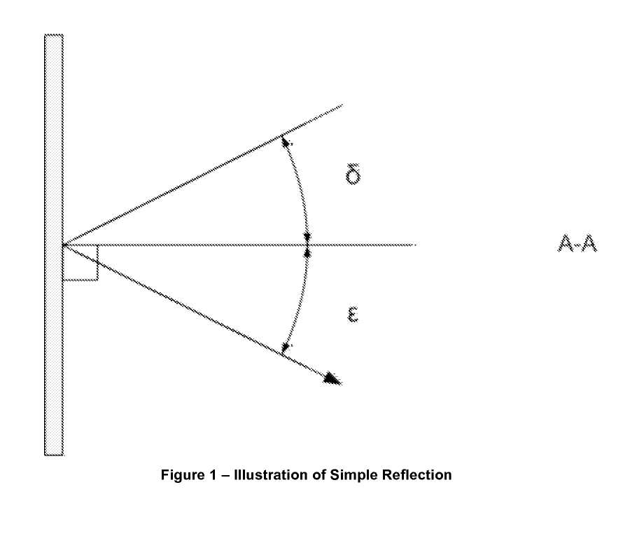

FIG. 2 is an illustration of what is defined as “Rotated Perpendicular Simple Reflection.”

FIG. 3 depicts a typical 25 meter calibration target for use with visible sights.

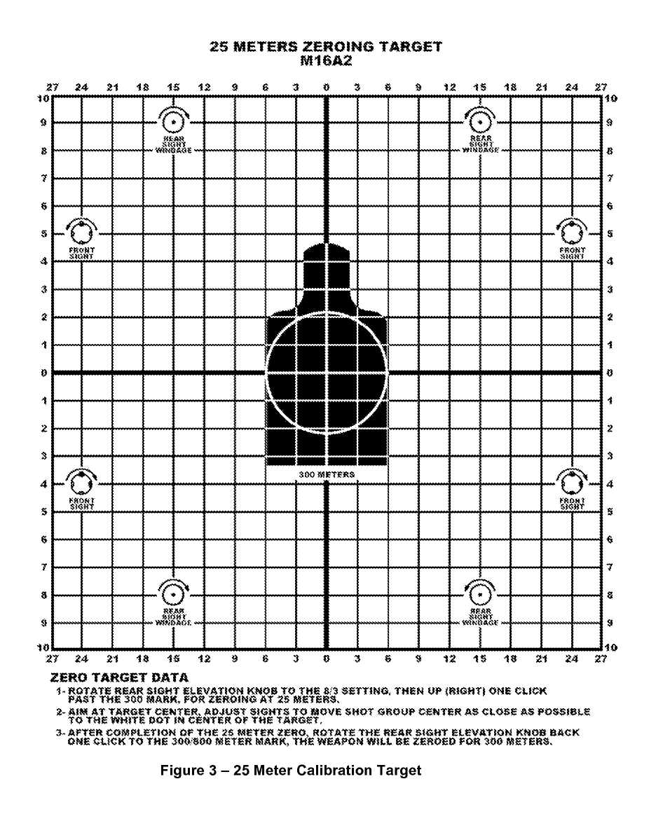

FIG. 4 depicts a second surface of the laminar member having a low emissivity.

FIG. 5 is an illustration of the perpendicular or substantially perpendicular plane along an axis connecting the observer and the low emissivity surface of the laminar member.

FIG. 6 is an illustration of the preferred saw-tooth construction of the low emissivity surface of the laminar member reflecting thermal radiation at a perpendicular orientation.

FIG. 7 is an illustration of a preferred construction of the laminar member of the invention.

FIG. 8 is an illustration of the laminar member wherein portions of the low emissivity surface have been printed on and removed to alter emissivity.

FIG. 9 is an illustration of a calibration target printed on the low emissivity surface of the laminar member.

FIG. 10 is an illustration of the appearance of the laminar member as illustrated in FIG. 6 to a thermal imager.

FIG. 11 is an illustration of a laminar member as illustrated in FIG. 5 adhered to a support layer.

FIG. 12 is an illustration of a supported laminar member, wherein a portion of the low emissivity surface of the member has been removed to alter emissivity.

FIG. 13 is an illustration of the appearance of the signage as illustrated in FIG. 9 to a thermal imager.

FIG. 14 is an illustration of a laminar member with a heat source.

### DETAILED DESCRIPTION OF PREFERRED EMBODIMENTS OF THE INVENTION

The present invention will now be described in details with reference to exemplary embodiments of the invention. The following detailed description should not be considered as a limitation on the invention, but rather should be considered as a detailed description of certain embodiments, which is presented to give those of skilled in the art a more complete understanding of the various features of the invention.

For purposes of this invention, the term “signage” is used herein to mean a sign, marker or an object, typically a laminar, which conveys some information, whether simple or complex, to an observer.

For purposes of this invention, the term “emissivity” is used herein to mean the ratio of the thermal energy radiated or emitted by a surface as compared to that radiated or emitted by a blackbody at the same temperature.

For purposes of this invention, the term “black body” is used herein to mean an object that can absorb and send off radiation with complete efficiency—that is, it reflects none of the radiation that falls on it and perfectly emits radiation as a function of temperature.

For purposes of this invention the term “substantially vertical” is used herein to mean at an angle of 30° or less of vertical and preferably at an angle of 5° or less of vertical.

For purposes of this invention the term “substantially perpendicular” is used herein to mean at an angle of 30° or less of perpendicular and preferably at an angle of 5° or less of perpendicular.

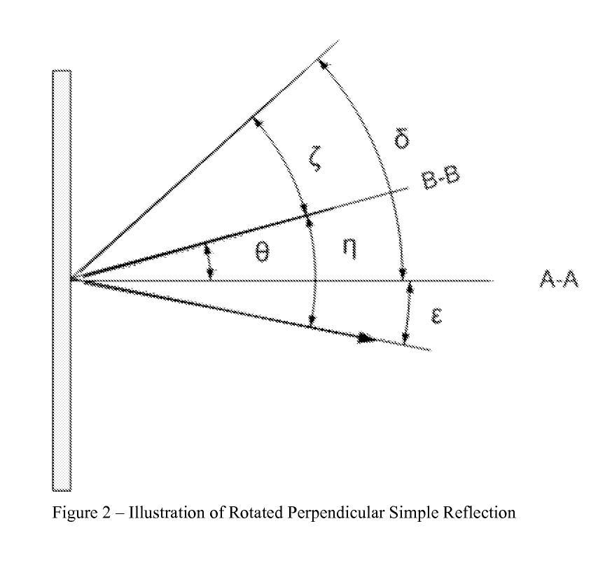

The present invention utilizes a reflective film characterized by “rotated perpendicular simple reflection”. For purposes of the present invention the term “rotated perpendicular simple reflection” is used herein to designate when a ray of energy striking the film is reflected and follows a path shown in FIG. 2 such that the angle, δ, between a ray striking the surface and a line, AA, perpendicular to the surface of the reflective film, is significantly greater than the angle, ε, between the reflected ray and the perpendicular line, AA (that is the angle δ is more than double the angle ε). The film functions as if the perpendicular line, AA, were rotated through an angle, θ, to create a new line BB. In this case, the angle ζ between a ray striking the surface and the rotated line, BB, is exactly equal to the angle η, as shown in FIG. 2. In accordance with a preferred embodiment of the invention, the reflective film is oriented substantially vertically to the earth rather than having to be rotated away from vertical as described in

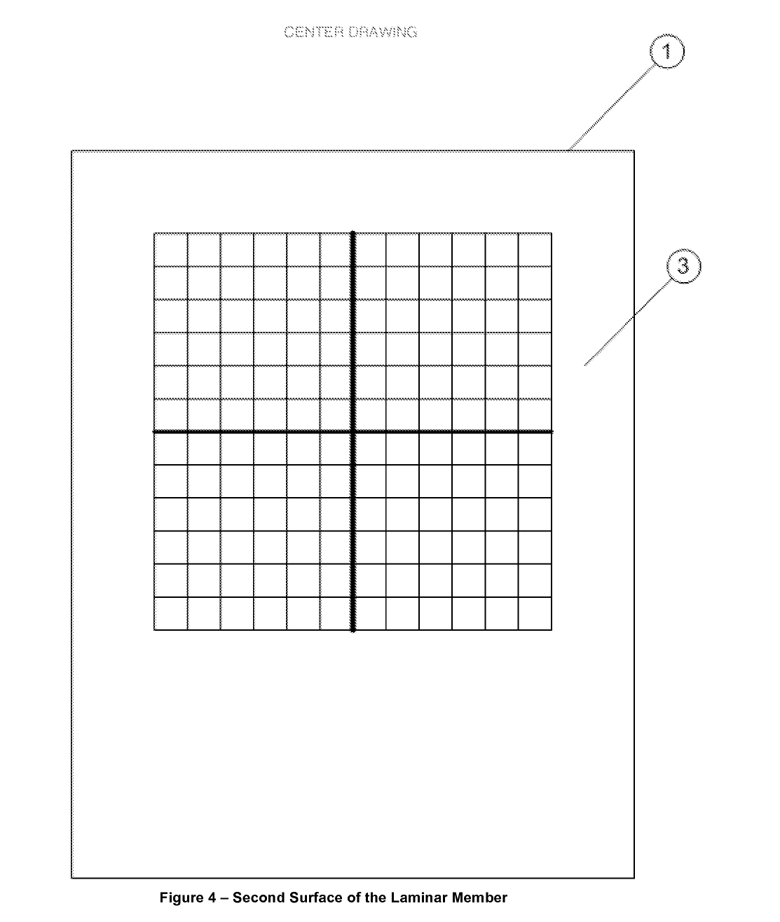

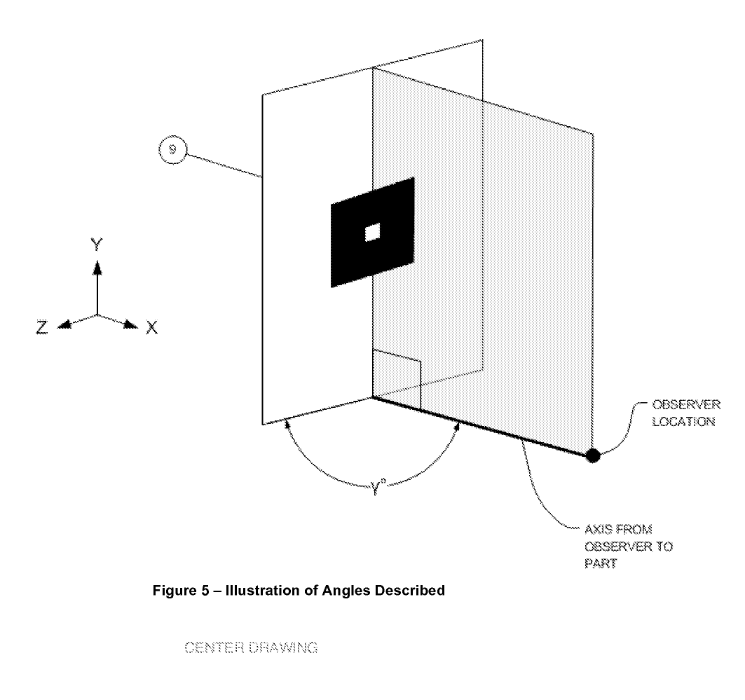

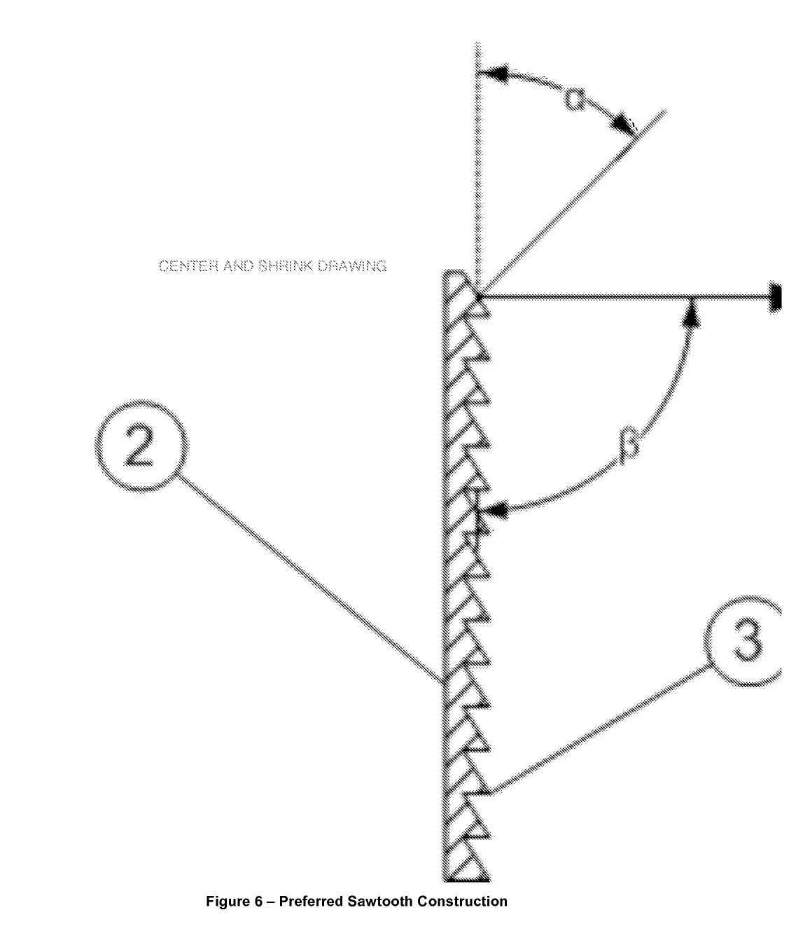

As shown in FIG. 4, the signage of the invention generally comprises a laminar member (1) having a first surface (2) and second surface (3). Surface (3) generally has a low emissivity value (i.e., an emissivity value of about 0.4 or less). When the laminar member is oriented vertically or substantially vertically to the earth, an observer viewing the member will observe at least a portion of the thermal energy of the sky reflecting off the surface (3). Preferably, the thermal energy striking the surface (3) is reflected perpendicular or substantially perpendicular towards the observer as shown in FIG. 5. Most preferably, the thermal energy striking the surface (3) is reflected perpendicular or substantially perpendicular along a vertical axis connecting the observer and the surface (3). In a preferred embodiment of the invention, at least a portion of the thermal energy of the sky striking the surface (3) at an angle (α) of less than 90°, preferably at an angle (α) of approximately 10°, is reflected towards an observer. In an even more preferred embodiment these reflective properties are developed using a laminar member (1) wherein the surface (3) has been etched, molded or otherwise modified to have sawtooth pattern or profile as shown in FIG. 6.

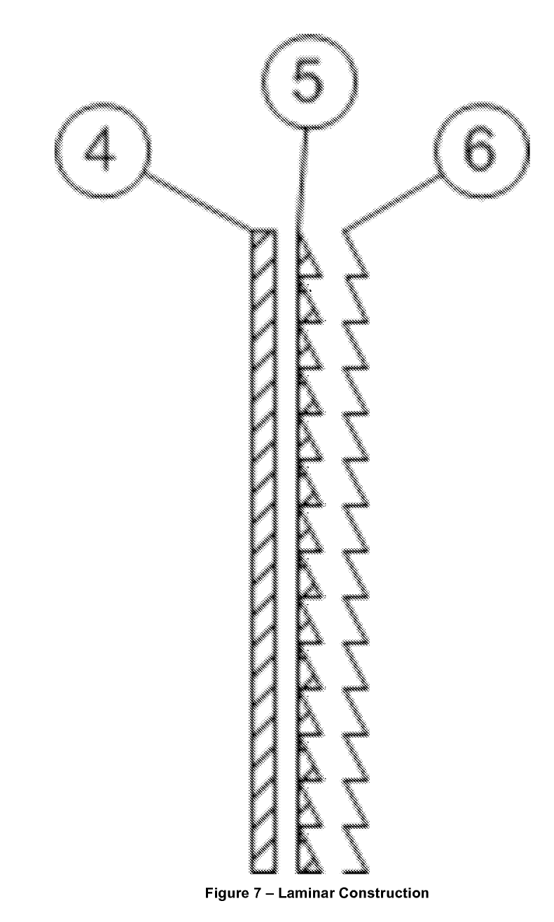

The laminar member (1) may comprise one or more film layers. In a preferred embodiment, the laminar member (1) comprises multiple film or deposition layers (4), (5), and (6) as shown in FIG. 7. Layer (4) comprises a base film layer on which the other layers are developed. This layer may be comprised of a polymeric material selected from the group consisting of polyester, polyethylene, polyvinyl chloride and mixtures thereof Layer (5) comprises an intermediate layer having a surface configuration sufficient to reflect at least a portion of the thermal energy of the sky striking the surface towards an observer, when the layer is orientated vertically or substantially vertical to the earth. Preferably, layer (5) has a surface characteristic such that the thermal energy of the sky striking the surface is reflected perpendicular or substantially perpendicular towards an observer. Most preferably, layer 5 has a construction such that the thermal energy of the sky striking the surface (3) at an angle (α) of less than 90°, most preferably, at an angle of about 10°, is reflected towards an observer.

In a preferred embodiment, layer (5) comprises a sawtooth pattern etched, molded, or otherwise formed or deposited on the surface thereof. In general, any conventional tooling capable of forming the desired pattern on the surface may be used to prepare the surface of layer (5). Preferably, the tooling is a drum with a diamond etched pattern suitable to form a sawtooth pattern. While a sawtooth pattern is preferred, it will be understood by one skilled in the arts that any pattern sufficient to provide the desired thermal energy reflecting characteristics will be useful to prepare the film layer (5).

The final layer (6) is coated, deposited, or applied onto layer (5) in such a manner to conform to the surface construction of layer (5) and provide a low emissivity surface thereon, i.e. a surface having a emissivity value of about 0.4 or less. It is within the scope of the present invention that any low emissivity material capable of forming a conformable, uniform coating on the patterned surface can be used. Preferably, layer (6) comprises a shiny metal, such as for example, sputtered aluminum, gold, silver, or mixtures thereof. The low emissivity coating may be applied using conventional coating techniques such as for example, spraying, electrolysis, deposition, or sputtering.

In a most preferred embodiment of the invention, the laminar member (1) is a multilayer film currently available under the trade name, Mirage V™ from QinetiQ (UK) located in Farnborough Hampshire GU14 0LX, United Kingdom.

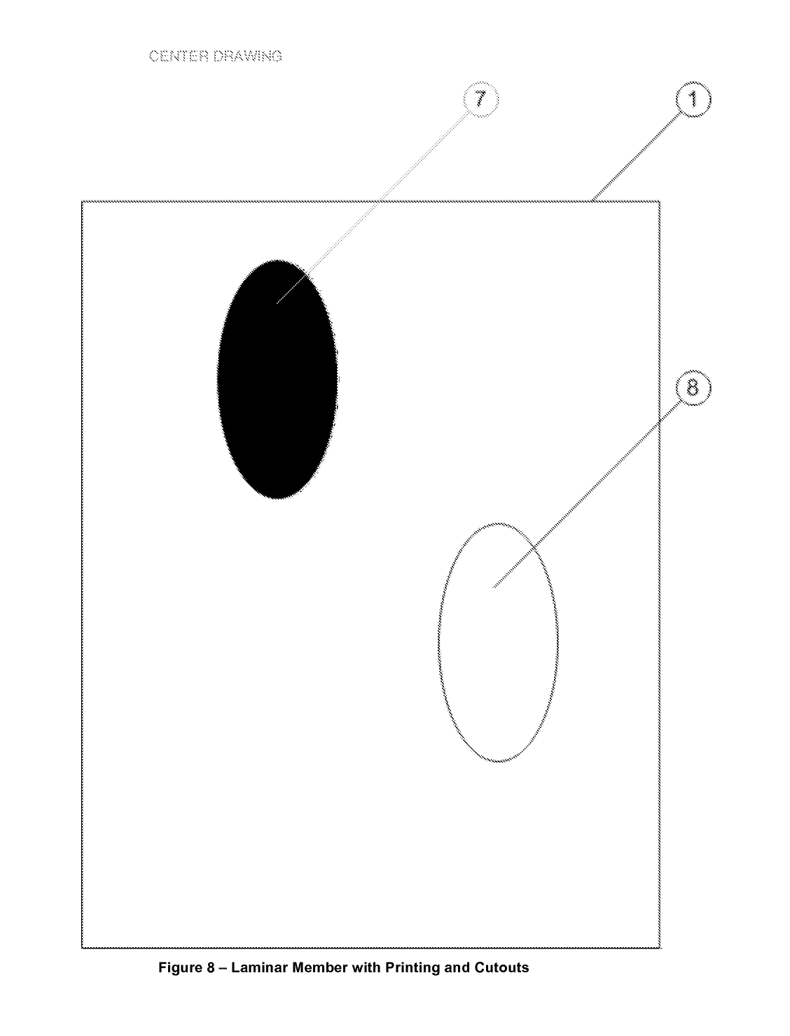

The emissive characteristics of the laminar member (1) may be altered by applying a printed coating (7) having a thickness and type sufficient to provide a desired emissivity value on at least one portion of the surface (3), or by removing a portion of the surface to form a cut-out shape (8) as shown in FIG. 8. In either case, printing on or removal of at least a portion of the surface (3) increases the emissivity value in the area of the printing or cutout portion. Typically, the printed coating (7) or cutout shape (8) will have a high emissivity value (i.e. an emissivity value of greater than 0.4, preferably greater than 0.6).

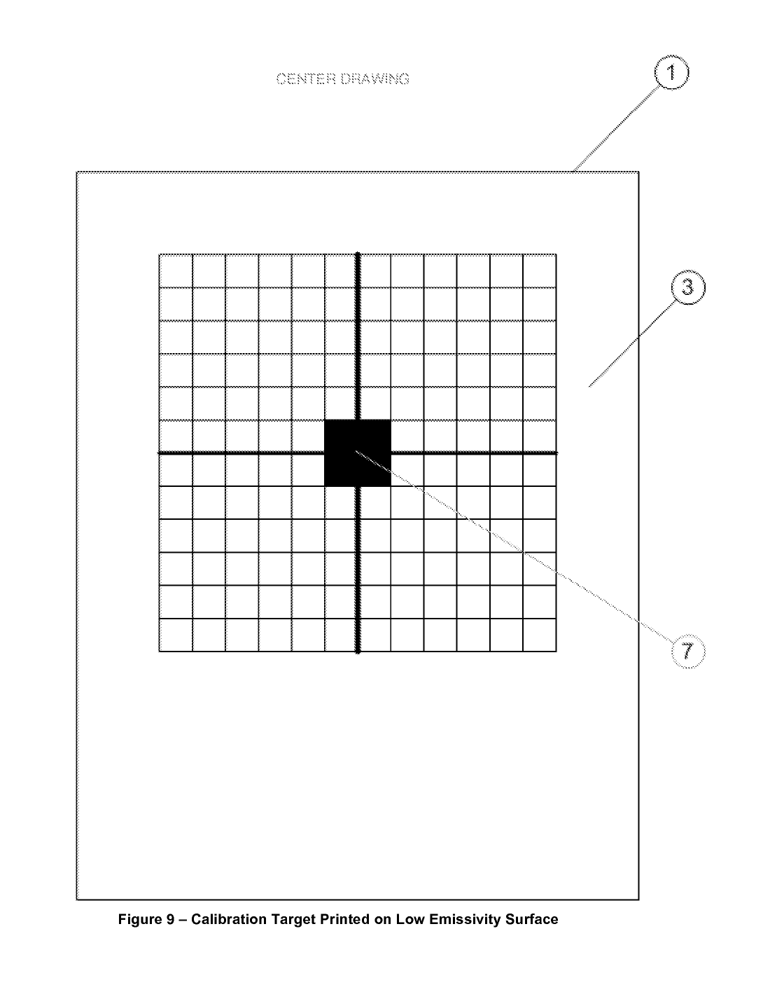

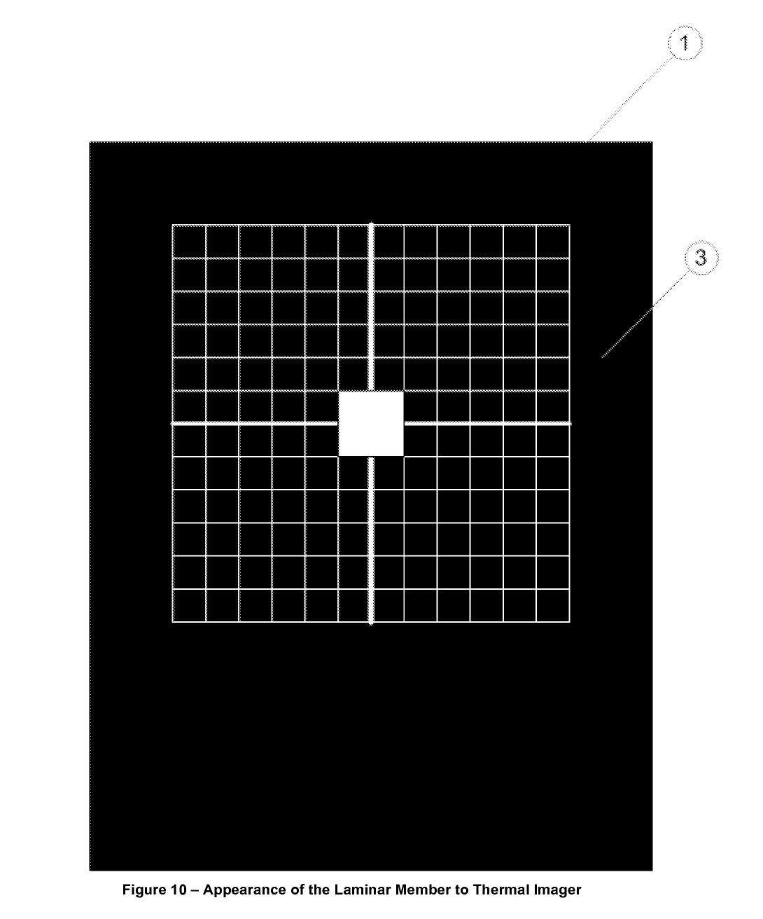

The printed coating (7) and cutout shape (8) will typically be formed in a manner such that desired words, symbols, graphics, messages or signals are communicated. In a preferred embodiment shown in FIG. 9, the printed coating (7) creates a lesser portion which has a high emissivity value (i.e. an emissivity of greater than 0.4, preferably greater than 0.6) on surface (3), while a major portion of the surface (3) retains a low emissivity value of about 0.4 or less. This forms a target which may be used to calibrate a weapon to a thermal scope. When viewed through the thermal scope, the major portion of the surface (3) having a low emissivity value appears black and the lesser portion of the surface (3) having a high emissivity value appear grey to white, such as shown, for example, in FIG. 10.

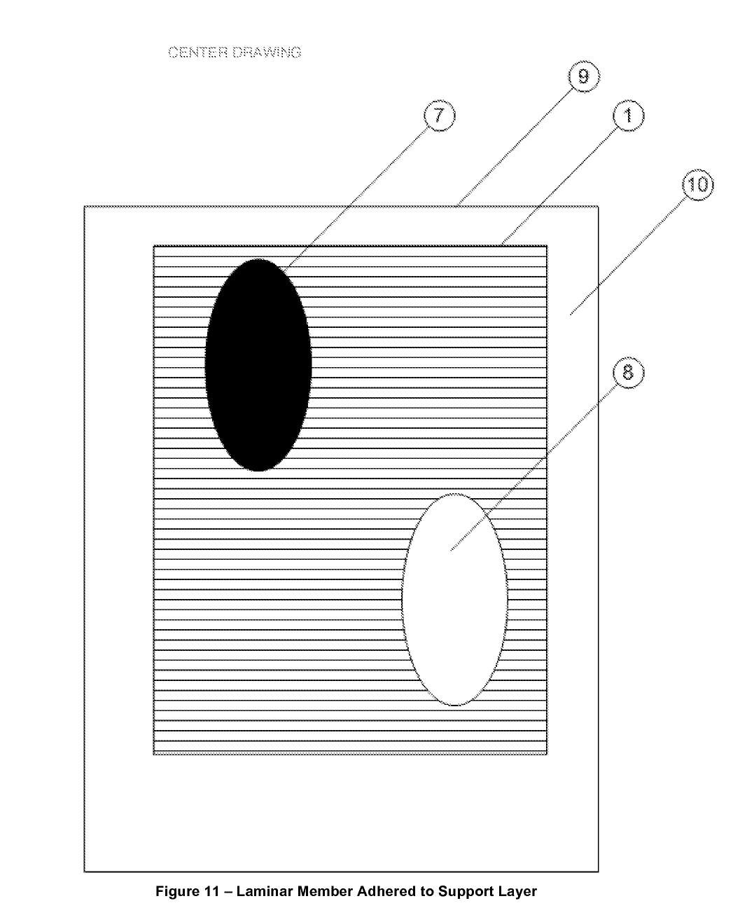

In a second embodiment of the invention, the laminar member (1) is attached to a support (9) having a first surface and second surface (10), as shown in FIG. 11. Preferably, the laminar member (1) is attached to the second surface of the support (9). The support (9) may be attached to the laminar member (1) using any conventional bonding means, such as for example, adhesives, heat-sealing, epoxies, and the like. In a preferred embodiment of the invention, both surfaces of the support (9) have a high emissivity value (an emissivity value of greater than 0.4). The support (9) provides increased rigidity to the laminar member. The support (9) may be made from any suitable material capable of providing the desired rigidity and support. Suitable materials include, but are not limited to, paper, SBS paperboard, cardstock, cardboard, plastics, metallics, painted metallics or a mixture thereof. Preferably, the support (9) is made from cardstock.

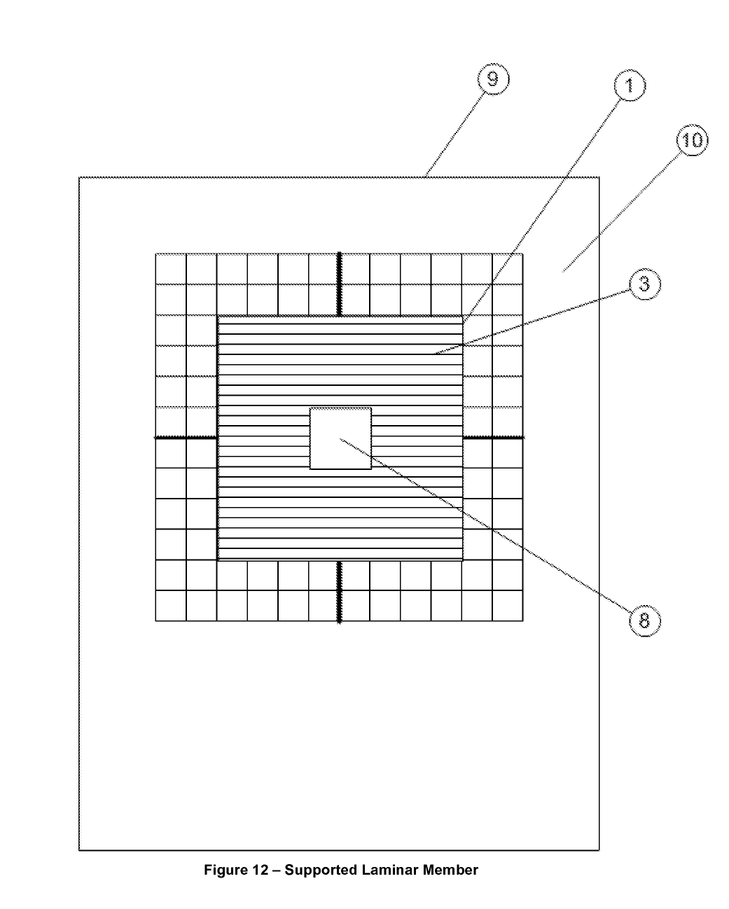

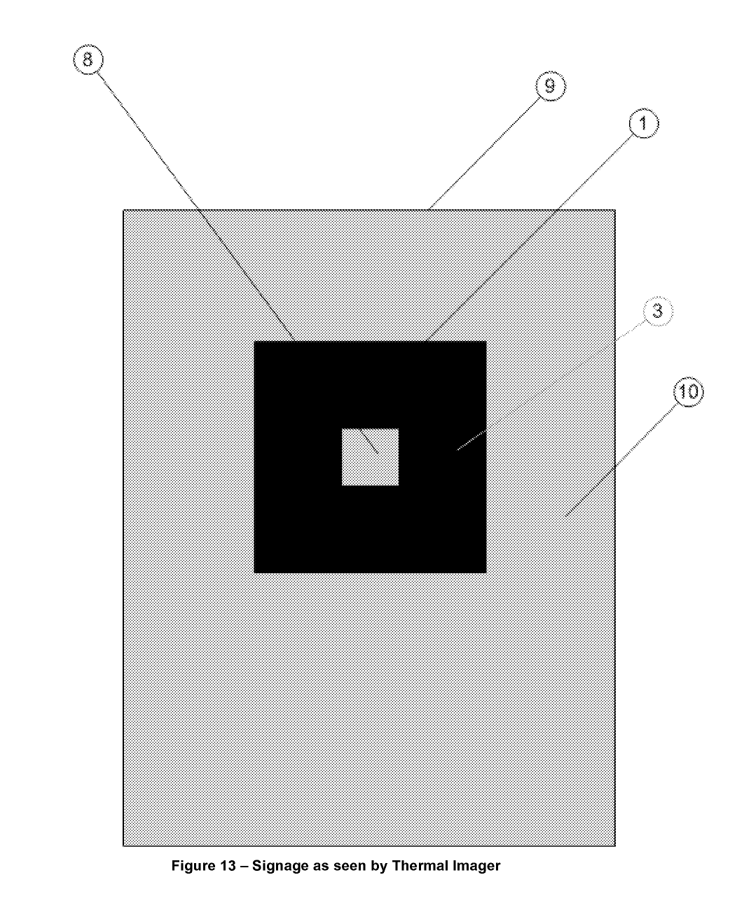

The support (9) may be used in combination with a laminar member (1), preferably to provide an article wherein the thermal energy striking the low emissivity surface of the laminar member is reflected perpendicular or substantially perpendicular along a vertical axis connecting the observer and the low emissivity surface as shown in FIG. 5. The signage forms a target useful to calibrate a weapon to a thermal scope. In a preferred embodiment, a 25 Meter Calibration Target or any other object or pattern of interest may be printed on the surface (10) of the support. An exemplary sample target appears in FIG. 12. When viewed through a thermal scope, the appearance of the supported laminar member is as shown in FIG. 13 where the low emissivity surface (3) appears black and the high emissivity cutout shape (8) appear grey to white.

To calibrate a weapon sight, the practitioner sets the target vertical or substantially vertical to the earth so that the sky reflects off the surface (3) and can be seen through the thermal scope by the practitioner. An appropriate number of rounds or shot groups are then fired at the center of the target. After analyzing the distance from a centroid of the shot group to the expected point of impact, the scope alignment is adjusted so that the centroid of the shot group is coincident with a predetermined location on the target.

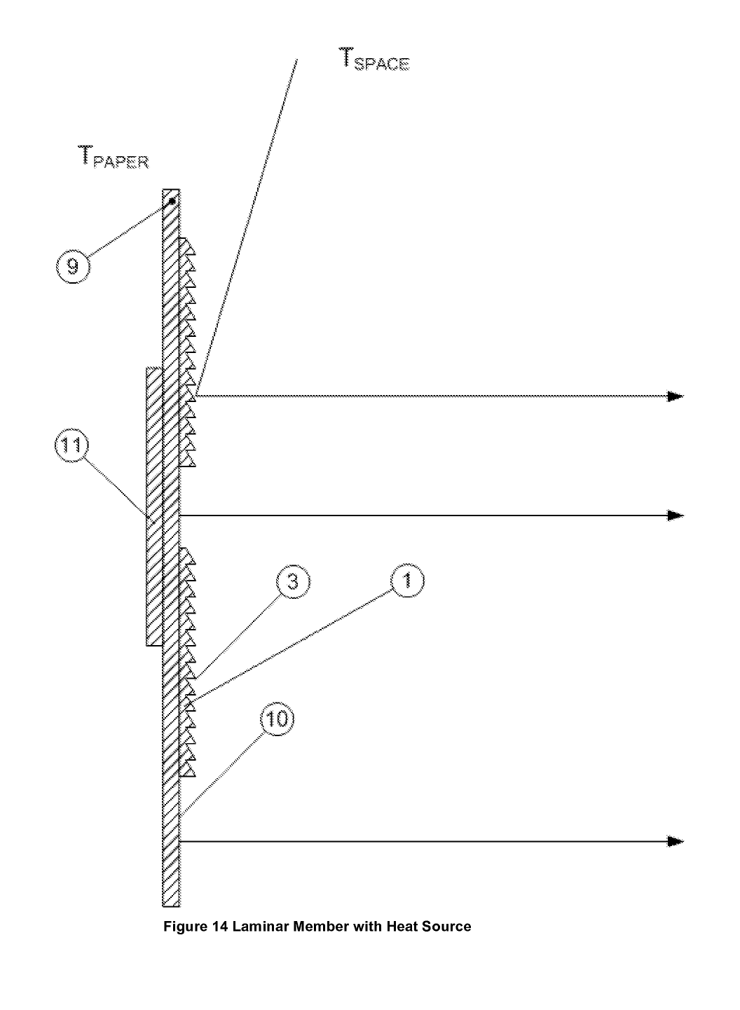

To provide further increase clarity to the thermal weapons sight, the laminar member (1) may be completely or partially heated, as depicted in FIG. 14 using a heat source (11). In the area where heat is applied, the difference in infrared energy emitted from a low emissivity surface and a high emissive surface in the signage device will increase. As this difference increases, the clarity in the thermal weapon sight will increase due to increased contrast. It may be desirable to adjust the detector gain and contrast for optimum clarity.

In a preferred embodiment, a heat source is attached to the first surface of the laminar member (9). The heat source may be a chemical heater (11), such as a Toasti Toes from Heatmax, which begins to heat when exposed to oxygen in the air. The entire target or just the heater may be packaged in an air-tight package to prevent the heater from operating before use. In one embodiment, the chemical heater is completely biodegradable, which minimizes the cost and logistics of disposal. It should be noted that for this embodiment the support (9) could be omitted and the heat source applied directly to surface (2) of the laminar member.

In yet another embodiment, the heat source may be an electrical heat source such as for example, an electric heater. Preferably the electric heater begins to heat when an electric voltage is applied to it. In one embodiment, an electrical power source such as a battery may be used. Preferably, the power source has a means for preventing a current from flowing until the heat is desired, such as for example, a pull tab. In this case, when the tab is removed, the circuit is connected and current flows heating the heater. Any method preventing current flow is contemplated by the present invention.

Further, any other conventional means of providing heat to a film or film laminate is contemplated for use by the invention provided it does not interfere with the intended use of the signage device of the invention. For example, Migliorini (U.S. Pat. No. 6,337,475) discloses placing an electric heater on the second surface of a paper target, which has high or normal emissivity. The effectiveness of this is dependent on the effectiveness of the thermal insulating layer. If not completely effective, the silhouette shape will become distorted. On the other hand, the heater shape does not have to assume a specific shape for the present invention because the infrared image is created on the front surface and is a function of the cut-out shape (8) and the print coating (7) and not the geometry of the heater.

Generally, the heat source is attached to the laminar member by any conventional bonding means. Preferably, the heat source is attached to the laminar member by a bonding means which permits bonding over the entire surface of the heat source, such as for example, by using an adhesive, in particular a pressure sensitive adhesive.

In the practice of one embodiment of the invention relating to a 25 m target, the weapons user will remove the target and/or heater from its package. If a heater is used and if not already affixed to the rear of the target, the heater is affixed there and the assembly is placed on a fixture. The weapons user, or shooter, returns to the shoot position typically about twenty-five meters from the target. The chemical heater will begin to react, warming the target. When viewed through the thermal weapon sight, the aim point will be very visible. The shooter will shoot at the aim point in the center of the target. After shooting, the shooter will note the location of the rounds relative to the expected point of impact and, if needed, adjust his sights to bring the rounds to the desired point of impact.

1. The examples, which follow, are given for illustrative purposes and are not meant to limit the invention described herein.

### EXAMPLES

### Example 1

A piece of Mirage V film (obtained from QinetiQ, United Kingdom), approximately 5″×5″, was sized to cover a grid 12 cells by 12 cells in the exact center of a larger 18 cell by 20 cell grid. A 2 cell by 2 cell section was removed from the center of the part. The part was carefully oriented such that the perpendicular from the major portion of the sawtooth profile generally pointed toward the top of the paper. This ensured that the thermal reflections would be in keeping with those described the patent. The rear of the film was coated with 3M Super 77 spray adhesive and then the film was adhered to the center of the printed grid on the ALT-C(2) M16A2 paper target. In this case the user shoots at the center of the target 3 times and adjusts their scope based on the difference between the point of aim and point of impact.

### Example 2

A piece of Mirage V film (from QinetiQ in the United Kingdom), approximately 5″×5″, was sized to cover a grid 12 cells by 12 cells in the exact center of the larger 18 cell by 20 cell grid. A 2 cell by 2 cell section was removed from the center of the part. The part was carefully oriented such that the perpendicular from the major portion of the sawtooth generally pointed toward the top of the paper. This ensured that the thermal reflections would be in keeping with those described the patent. The rear of the film was coated with 3M Super 77 spray adhesive and then the film was adhered to the center of the printed grid on the ALT-C(2) M16A2 paper target. A Toasti-Toes heater was placed on the rear of the target just behind the film cutout. This gave a very bright signature directly in the center of the target. In this case the user can shoot at the center of the target 3 times and adjust their scope based on the difference between the point of aim and point of impact.

### Example 3

A piece of Mirage V film (obtained from QinetiQ, United Kingdom), approximately 5″×5″, was sized to cover a grid 12 cells by 12 cells in the exact center of a larger 18 cell by 20 cell grid. A 2 cell by 2 cell section was removed from the center of the part. The part was carefully oriented such that the perpendicular from the major portion of the sawtooth generally pointed toward the sky. This ensured that the thermal reflections would be in keeping with those described the patent. A simple template was cut out of paper and placed in intimate contact with the film. The film was painted with the black spray paint, and the template was removed. When observed with the thermal imager the printed areas appeared warmer than the non-printed areas.

The invention claimed is:

1. A method of calibrating an infrared sight to a weapon comprising providing a target having a center point; viewing the target through an infrared sight to determine a point of aim and provide a desired point of impact at the center point of the target;
shooting a round of shots at the target;
viewing the location of the shots on the target relative to the desired point of impact on the target; and optionally, adjusting the infrared sight such that the point of aim coincides with the desired point of impact on the target;
wherein the target comprises a laminar member comprising a first surface and a second surface, the second surface having a major portion and at least one lesser portion to provide the center point of the target, wherein the major portion has a low emissivity value of about 0.4 or less and the at least one lesser portion has an emissivity value of greater than 0.4 and wherein the second surface has a construction which reflects at least a portion of the thermal energy of the sky striking the second surface towards an observer when the laminar member is orientated vertical or substantially vertical to the earth.

2. The method of claim 1 wherein the thermal energy from the sky strikes the second surface at an angle of less than 90°.

3. The method of claim 2 wherein the thermal energy from the sky strikes the second surface at an angle of about 10°.

4. The method of claim 1 wherein the construction of the second surface reflects the thermal energy from the sky perpendicularly or substantially perpendicularly towards an observer.

5. The method of claim 4 wherein the thermal energy of the sky is reflected along a vertical axis connecting the second surface and the observer.

6. The method of claim 1 wherein the surface construction of the second surface of the laminar member is characterized by rotated perpendicularly simple reflection.

7. The method of claim 6, wherein the surface construction of the second surface comprises a sawtooth configuration.

8. The method of claim 7, wherein the laminar member comprises base film layer, an inner layer and an outer layer wherein said outer layer comprises the second surface of the laminar member.

9. The method of claim 8, wherein the outer layer is conformally coated onto inner layer of the laminar member.

10. The method of claim 1 wherein the lesser portion of the second surface comprising printing selected from the group consisting of words, symbols, graphics, other printed creations, and combinations thereof, having a thickness and a type sufficient to provide an emissivity value of greater than 0.4.

11. The method of claim 1 or 10 wherein the lesser portion on the second surface comprises at least one cutout shape wherein the laminar member has been removed to provide a portion having an emissivity value of greater than 0.4.

12. The method of claim 1 wherein the laminar member further comprises at least one heat source.
